(19) United States
(12) Patent Application Publication
(10) Pub. No.: US 2005/0068258 A1
(43) Pub. Date: Mar. 31, 2005

(54) Light emitting device with optical enhancement structure

(75) Inventors: An-Chi Wei, Keelung City (TW); Heng-Long Yang, Taipei City (TW); Han-Ping Shieh, Hsinchu City (TW)

Correspondence Address: LIU & LIU, 811 WEST 7TH STREET, SUITE 1100, LOS ANGELES, CA, 90017, US

(73) Assignee: Toppoly Optoelectronics Corp.

(21) Appl. No.: 10/939,017

(22) Filed: Sep. 9, 2004

(30) Foreign Application Priority Data
Sep. 9, 2003 (TW) 92124844
Sep. 12, 2003 (TW) 92125333

(51) Int. Cl. G09G 3/20

(52) U.S. Cl. 345/55

(57) ABSTRACT

A light emitting device with optical enhancement structure. The light emitting device includes a light emitting element and an optical enhancement structure. Some of the light from the light emitting element is emitted in a diverging manner. The optical enhancement structure is optically coupled to the light emitting element, said optical enhancement structure having a light emerging surface that includes a central surface that is orthogonal to the normal and corner surfaces having profiles that are not orthogonal to the normal. The optical enhancement structure is a single structure for changing the normal angle of the first light emerging surface to increase light output efficiency.

### BACKGROUND OF THE INVENTION

1. Field of the Invention

The present invention relates to light emitting devices, and more particularly to an organic light emitting device including an optical enhancement structure.

This invention relates to concurrently filed, copending patent application Ser. No. ______ (Attorney Docket No. 1176/212), which has been commonly assigned to the assignee of the present invention.

2. Description of the Related Art

Light output efficiency in conventional organic light emitting devices (OLED) and polymer light emitting devices (PLED) is insufficient due to total internal reflection (TIR) and the waveguide effect. Therefore, the actual light output efficiency is still very low although the internal quantum efficiency is near 100%.

FIG. 3 is a cross-section of a conventional organic light emitting device, only showing a pixel region for simplicity. The pixel includes a substrate 10, a reflective anode 20 formed on the substrate 10, an organic light emitting layer 22 formed on the reflective anode 20, a transparent cathode 24 formed on the organic light emitting layer 22, and a passivation layer 900 formed on the transparent cathode 24. This conventional pixel does not add an optical enhancement structure as in the present invention. As shown in FIG. 3, when the light beam L₁, emitted from the edge of the organic light emitting layer 22, reaches the interface between the passivation layer 900 and the air, if the incident angle θ₁ exceeds the critical angle, total reflection occurs and the totally-reflected light beam is referred to as Lₜ.

Möller et al. use hemispherical micro-lens arrays to enhance light output efficiency of an OLED (J. of Appl. Phys., Vol. 91, No. 5, pp.3324-3327, 2002). FIG. 1 shows a cross-section of a pixel of an OLED designed by Möller. Label 100 indicates a glass substrate, 200 a transparent anode, 220 an organic light emitting layer, 240 an opaque cathode, and 300 a hemispherical micro-lens array. By means of the complicated interface of the hemispherical micro-lens, light output angle changes. Thus, while light output efficiency is enhanced, the enhancement is not high enough.

### SUMMARY OF THE INVENTION

The present invention solves the above-mentioned problems and provides a light emitting device with high light output efficiency. The present invention places a specially-designed optical enhancement structure along light output pathway of the light emitting device. By means of the special profile of the optical enhancement structure, the total internal reflection effect is reduced, thus enhancing light output efficiency of the organic light emitting device.

In one aspect of the present invention, the light emerging surface of the optical enhancement structure is provided with a surface profile that reduces internal reflection. In one embodiment, the light emerging surface includes a central surface that is orthogonal to the normal and corner surfaces having profiles that are not orthogonal to the normal. The corner surface profiles may be at least one of an arcuate profile, a faceted profile, and a beveled profile. In another embodiment, light emerging surface include a convex surface, which may be an arcuate profile extending across the light emerging surface.

The optical enhancement structure may also serve additional functions, such as passivation of underlying layers, in addition to enhancing the light output. In other words, the optical enhancement layer could be combined with other layers such as the passivation layer, cathode layers, etc.

In one embodiment of the present invention, the light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first optical enhancement structure is a single structure for changing the normal angle of the first light emerging surface to increase light output efficiency.

According to another embodiment of the present invention, the organic light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first light emerging surface is an arced surface, a surface composed of a plurality of connecting slanted surfaces with gradually changed slopes, or a combination thereof.

According to a further embodiment of the present invention, the organic light emitting device includes a plurality of pixels, each including a first electrode; an organic light emitting layer formed on the first electrode; a second electrode formed on the organic light emitting layer; and a first optical enhancement structure formed on the second electrode, such that light emitted from the organic light emitting layer can pass through the first optical enhancement structure and emerge from a first light emerging surface of the first optical enhancement structure. The first light emerging surface includes a first surface and a second surface. The first surface has a flat or arced profile, and the second surface is on the sides of the first surface and is an arced surface, a slanted surface, or a surface composed of a plurality of connecting slanted surfaces with gradually changed slopes.

### BRIEF DESCRIPTION OF THE DRAWING

FIG. 1 is a cross-section of a pixel of a conventional organic light emitting device with hemispherical micro-lens arrays.

FIG. 2 shows a basic structure of a pixel of an organic light emitting device of the present invention.

FIG. 3 is a cross-section of a pixel of a conventional organic light emitting device without an optical enhancement structure.

FIG. 4 is a cross-section of a pixel of an organic light emitting device according to a first embodiment of the present invention.

FIG. 5 is a cross-section of a pixel of an organic light emitting device according to a second embodiment of the present invention.

FIG. 6 is a cross-section of a pixel of an organic light emitting device according to a third embodiment of the present invention.

FIG. 7 is a cross-section of a pixel of an organic light emitting device according to a fourth embodiment of the present invention.

FIG. 8 is a cross-section of a pixel of an organic light emitting device according to a fifth embodiment of the present invention.

FIG. 9 is a cross-section of a pixel of an organic light emitting device according to a sixth embodiment of the present invention.

FIG. 10 is a cross-section of a pixel of an organic light emitting device according to a seventh embodiment of the present invention.

FIG. 11 is a cross-section of a pixel of an organic light emitting device according to an eighth embodiment of the present invention.

FIG. 12 is a cross-section of a pixel of an organic light emitting device according to a ninth embodiment of the present invention.

FIG. 13 is a cross-section of a pixel of an organic light emitting device according to a tenth embodiment of the present invention.

FIG. 14 is a cross-section of a pixel of an organic light emitting device according to an eleventh embodiment of the present invention.

FIG. 15 is a cross-section of a pixel of an organic light emitting device according to a twelfth embodiment of the present invention.

FIG. 16 is a cross-section of-a pixel of conventional organic light emitting device with hemispherical micro-lens arrays.

FIG. 17 is a schematic diagram illustrating a light emitting display device of the present invention, incorporating a controller.

FIG. 18 is a schematic diagram illustrating an electronic device, incorporating the light emitting display device of the present invention.

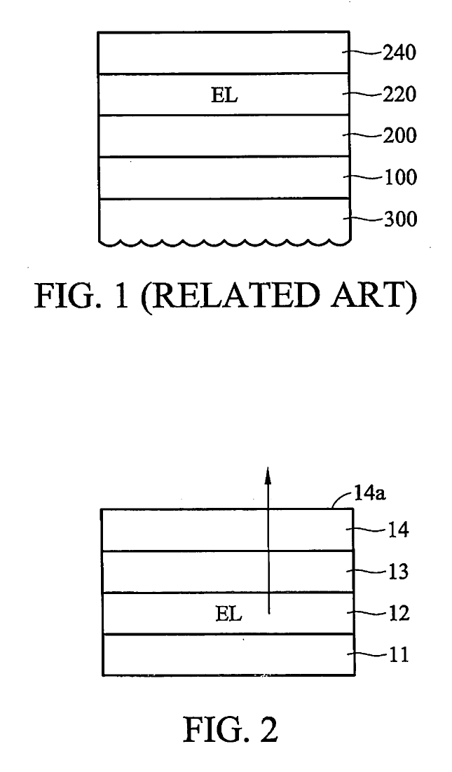

### DETAILED DESCRIPTION OF THE INVENTION

The present invention will be described below in connection with organic light emitting devices, to illustrate the general principle of the present invention. However, it is understood that the present invention is not limited to organic light emitting devices. Other types of light emitting devices can also take advantage of the present invention within the scope and spirit of the present invention.

FIG. 2 is a cross-section view illustrating an organic light emitting device according to a first embodiment of the present invention. For the sake of simplicity, FIG. 2 only shows a pixel region of the organic light emitting device. Further, there may be additional elements or components that are not shown in FIG. 2 but which may be present in the organic light emitting device.

Referring to FIG. 2, the pixel of the organic light emitting device includes a first electrode 11 formed on a glass substrate (not shown), an organic light emitting layer 12 formed on the first electrode 11, a second electrode 13 formed on the organic light emitting layer 12, and a first optical enhancement structure 14 formed on the second electrode 13. Light emitted from the organic light emitting layer 12 can pass through the first optical enhancement structure 14 and emerge from a first light emerging surface 14a of the first optical enhancement structure 14. The first optical enhancement structure 14 is a single structure and can reduce total internal reflection effect.

FIG. 4 is a cross-section of a pixel of an organic light emitting device according to a first embodiment of the present invention. The pixel includes a substrate 10, a reflective anode 20 formed on the substrate 10, an organic light emitting layer 22 formed on the reflective anode 20, a transparent cathode 24 formed on the organic light emitting layer 22, a passivation layer 26 formed on the transparent cathode 24, and a first optical enhancement structure 30 formed on the passivation layer 26.

The first optical enhancement structure 30 includes a first light emerging surface 31 and a bottom surface 32. The first light emerging surface 31 further includes a first surface 311 and a second surface 312. The first surface 311 has a flat profile. The second surface 312 is on the sides of the first surface 311 to connect with the bottom surface 32 and has an arced profile. Alternatively, the second surface 312 can be composed of a plurality of connecting slanted surfaces with gradually changed slopes.

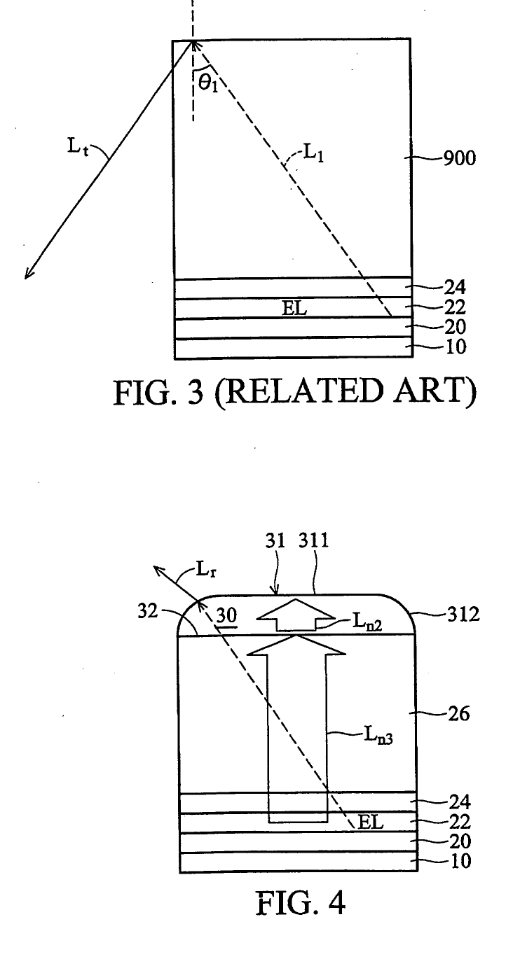

As shown in FIG. 4, when the light beam Lₙ₃ (the same location as in conventional FIG. 3), emitted from the edge of the organic light emitting layer 22, converges by the first optical enhancement layer 30 and successfully through the first optical enhancement layer 30 as the light beam Lₙ₂. Light beam reaches the second surface 312 of the first optical enhancement layer 30. Since the second surface 312 has an arcuate profile, the incident angle of the light bean is decreased to not exceed the critical angle. Thus, light beam will not be totally reflected but refract and emerge as the light beam Lᵣ. That is to say, the light beam that is otherwise totally reflected can refract and emerge by means of the second surface 312 of the first optical enhancement layer 30 of the present invention, thus further increasing light output efficiency.

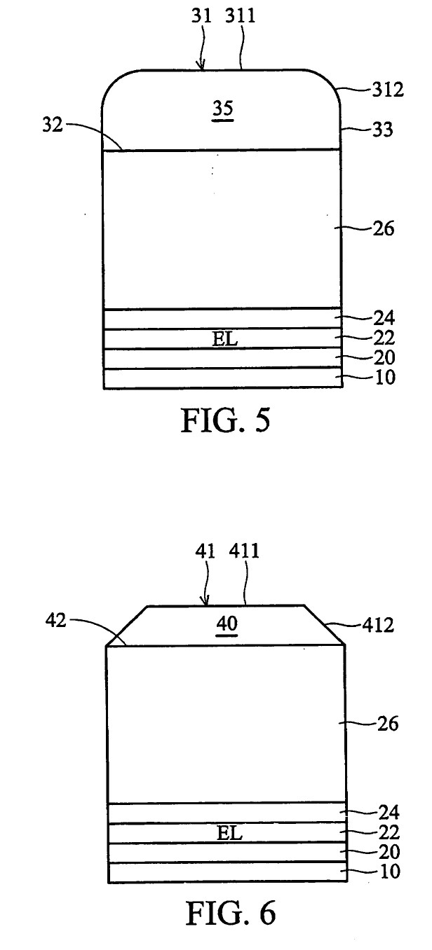

FIG. 5 is a cross-section of an organic light emitting device according to a second embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 5 differs from FIG. 4 in the first optical enhancement structure. In FIG. 5, the first optical enhancement structure 35 is formed on the passivation layer 26 and has a first light emerging surface 31, a bottom surface 32, and a sidewall 33. The first light emerging surface 31 includes a first surface 311 and a second surface 312. The first surface 311 has a flat profile, and the second surface 312 has an arcuate profile and is on the sides of the first surface 311. The second surface 312 connects the bottom surface 32 with the sidewall 33.

Similar to FIG. 4, the light beam totally reflected in the conventional OLED can refract and emerge by means of the optical enhancement structure 35 in FIG. 5 of the present invention, thus increasing light output efficiency.

FIG. 6 is a cross-section of an organic light emitting device according to a third embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 6 differs from FIG. 4 in the first optical enhancement structure. In FIG. 6, the first optical enhancement structure 40 is formed on the passivation layer 26 and has a first light emerging surface 41 and a bottom surface 42. The first light emerging surface 41 includes a first surface 411 and a second surface 412. The first surface 411 has a flat profile, and the second surface 412 has a slanted or faceted profile and is on the sides of the first surface 411 to connect the bottom surface 42.

Similar to FIG. 4, the light beam on the edge that is totally reflected originally no longer satisfies the total reflection condition by means of the slanted profile of the second surface 412. Thus, the light beam on the edge refracts and emerges, such that light output efficiency is enhanced.

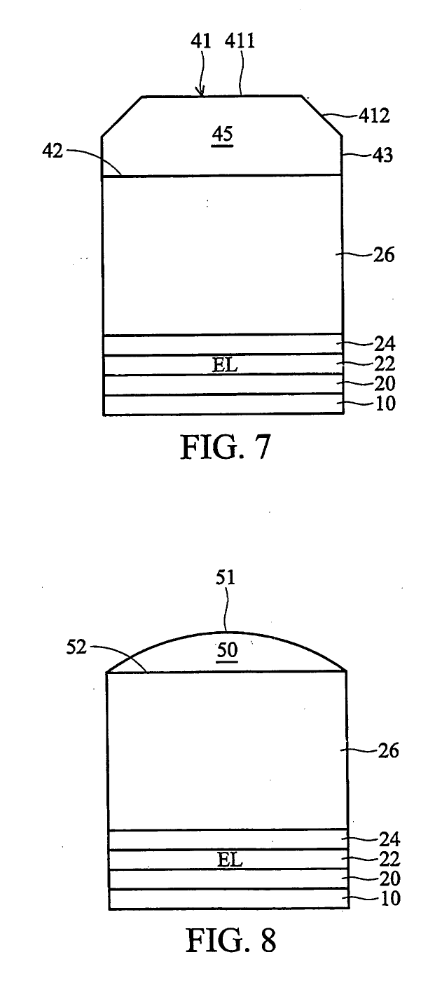

FIG. 7 is a cross-section of organic light emitting device according to a fourth embodiment of the present invention. The pixel includes a substrate. 10, a reflective anode 20, an organic light emitting layer 22, a transparent cathode 24, and a passivation layer 26. Corresponding elements are the same as in FIG. 4 and detailed descriptions are thus omitted here. FIG. 7 differs from FIG. 4 in the first optical enhancement structure. In FIG. 7, the first optical enhancement structure 45 is formed on the passivation layer 26 and has a first light emerging surface 41, a bottom surface 42, and a sidewall 43. The first light emerging surface 41 includes a first surface 411 and a second surface 412. The first surface 411 has a flat profile, and the second surface 412 has a slanted or faceted profile and is on the sides of the first surface 411. The second surface 412 connects the bottom surface 42 with the sidewall 43.

Similar to FIG. 6, since the second surface 412 has a slanted profile, the light beam on the edge that is totally reflected originally no longer satisfies the total reflection condition because of the presence of the first optical enhancement structure 45. Thus, the light beam on the edge refracts and emerges, such that light output efficiency is enhanced.

FIG. 8 is a cross-section of an organic light emitting device according to a fifth embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 8 differs from FIG. 4 in the first optical enhancement structure. In FIG. 8, the first optical enhancement structure 50 has a first light emerging surface 51 and a bottom surface 52. The first light emerging surface 51 has an arced profile.

Similar to FIG. 4, the light beam on the edge that is totally reflected originally no longer satisfies the total reflection condition because of the presence of the arced profile of the first light emerging surface 51. Thus, the light beam on the edge refracts and emerges, such that light output efficiency is enhanced.

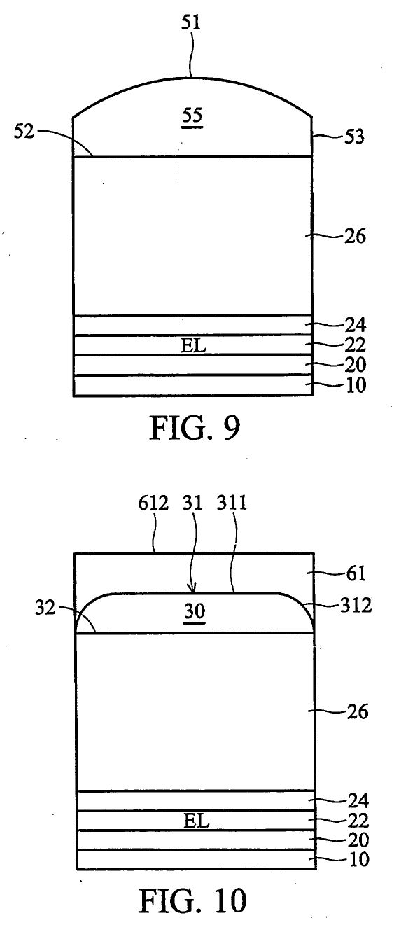

FIG. 9 is a cross-section of an organic light emitting device according to a sixth embodiment of the present invention. The pixel includes a substrate 10, a reflective anode 20, an organic light emitting layer 22, a transparent cathode 24, and a passivation layer 26. Corresponding elements are the same as in FIG. 4 and detailed descriptions are thus omitted here. FIG. 9 differs from FIG. 4 in the first optical enhancement structure. In FIG. 9, the first optical enhancement structure 55 is formed on the passivation layer 26 and has a first light emerging surface 51, a bottom surface 52, and a sidewall 53. The first light emerging surface 51 has an arced profile and connects the bottom surface 52 with the sidewall 53.

Similar to FIG. 8, the light beam on the edge that is totally reflected originally no longer satisfies the total reflection condition because of the presence of the arced profile of the first light emerging surface 51. Thus, the light beam on the edge refracts and emerges, such that light output efficiency is enhanced.

FIG. 10 is a cross-section of a pixel of an organic light emitting device according to a seventh embodiment of the present invention. Referring to FIGS. 4 and 10, FIG. 10 differs from FIG. 4 in that a second optical enhancement structure 61 is additionally disposed on the first optical enhancement structure 30. The second optical enhancement structure 61 adheres to the first optical enhancement structure 30 to constitute a doublet lens. Thus, light emitted from the organic light emitting layer 22 can sequentially pass through the first and second optical enhancement structures 30 and 61 and emerge from a second light emerging surface 612 of the second optical enhancement structure 61. The refractive index sequence (from large to small) is the passivation layer 26, the first optical enhancement structure 30, and the second optical enhancement structure 61.

Similar to FIG. 4, the light beam on the edge that is totally reflected originally no longer satisfies the total reflection condition because of the presence of the arced profile of the second surface 312 of the first optical enhancement structure 30. Thus, the light beam on the edge refracts and emerges, such that light output efficiency is enhanced.

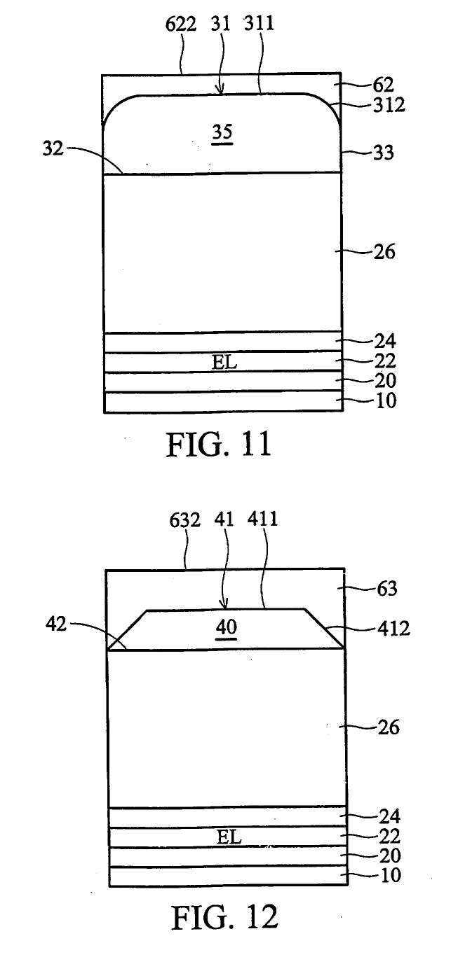

FIG. 11 is a cross-section of an organic light emitting device according to an eighth embodiment of the present invention. Referring to FIGS. 5 and 11, FIG. 11 differs from FIG. 5 in that a second optical enhancement structure 62 is additionally disposed on the first optical enhancement structure 35. Thus, light emitted from the organic light emitting layer 22 can sequentially pass through the first and second optical enhancement structures 35 and 62 and emerge from a second light emerging surface 622 of the second optical enhancement structure 62. The refractive index sequence (from large to small) is the passivation layer 26, the first optical enhancement structure 35, and the second optical enhancement structure 62.

Similar to FIG. 5, the light beam on the edge that is totally reflected originally no longer satisfies the total reflection condition because of the presence of the arced profile of the second surface 312 of the first optical enhancement structure 35. Thus, the light beam on the edge refracts and emerges, such that light output efficiency is enhanced.

FIG. 12 is a cross-section of an organic light emitting device according to a ninth embodiment of the present invention. Referring to FIGS. 6 and 12, FIG. 12 differs from FIG. 6 in that a second optical enhancement structure 63 is additionally disposed on the first optical enhancement structure 40. Thus, light emitted from the organic light emitting layer 22 can sequentially pass through the first and second optical enhancement structures 40 and 63 and emerge from a second light emerging surface 632 of the second optical enhancement structure 63. The refractive index sequence (from large to small) is the passivation layer 26, the first optical enhancement structure 40, and the second optical enhancement structure 63.

Similar to FIG. 6, the light beam on the edge that is totally reflected originally no longer satisfies the total reflection condition because of the presence of the slanted profile of the second surface 412 of the first optical enhancement structure 40. Thus, the light beam on the edge refracts and emerges, such that light output efficiency is enhanced.

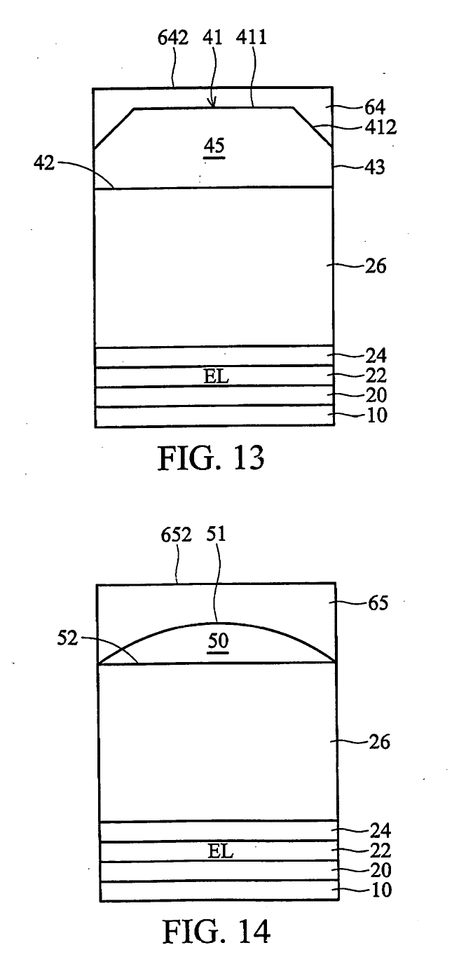

FIG. 13 is a cross-section of an organic light emitting device according to a tenth embodiment of the present invention. Referring to FIGS. 7 and 13, FIG. 13 differs from FIG. 7 in that a second optical enhancement structure 64 is additionally disposed on the first optical enhancement structure 45. Thus, light emitted from the organic light emitting layer 22 can sequentially pass through the first and second optical enhancement structures 45 and 64 and emerge from a second light emerging surface 642 of the second optical enhancement structure 64. The refractive index sequence (from large to small) is the passivation layer 26, the first optical enhancement structure 45, and the second optical enhancement structure 64.

Similar to FIG. 7, the light beam on the edge that is totally reflected originally no longer satisfies the total reflection condition because of the presence of the slanted profile of the second surface 412 of the first optical enhancement structure 45. Thus, the light beam on the edge refracts and emerges, such that light output efficiency is enhanced.

FIG. 14 is a cross-section of an organic light emitting device according to an eleventh embodiment of the present invention. Referring to FIGS. 8 and 14, FIG. 14 differs from FIG. 8 in that a second optical enhancement structure 65 is additionally disposed on the first optical enhancement structure 50. Thus, light emitted from the organic light emitting layer 22 can sequentially pass through the first and second optical enhancement structures 50 and 65 and emerge from a second light emerging surface 652 of the second optical enhancement structure 65. The refractive index sequence (from large to small) is the passivation layer 26, the first optical enhancement structure 50, and the second optical enhancement structure 65.

Similar to FIG. 8, the light beam on the edge that is totally reflected originally no longer satisfies the total reflection condition because of the presence of the arced profile of the first light emerging surface 51 of the first optical enhancement structure 50. Thus, the light beam on the edge refracts and emerges, such that light output efficiency is enhanced.

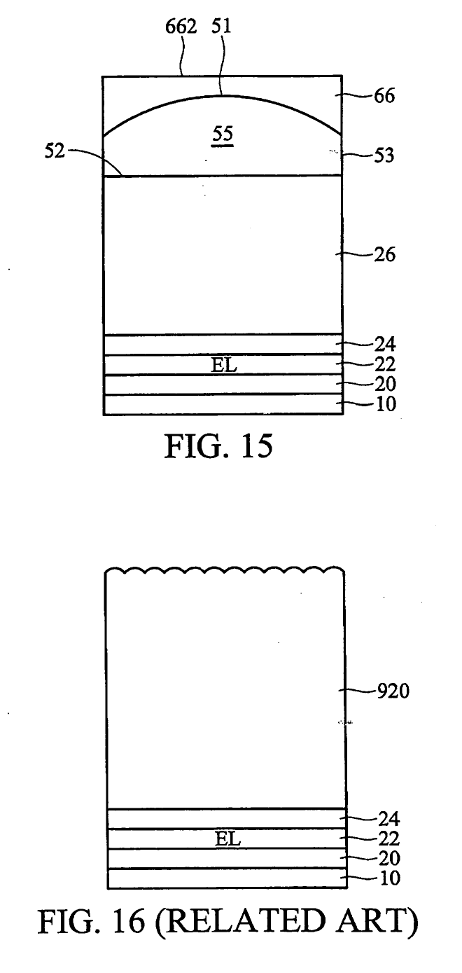

FIG. 15 is a cross-section of an organic light emitting device according to a twelfth embodiment of the present invention. Referring to FIGS. 9 and 15, FIG. 15 differs from FIG. 9 in that a second optical enhancement structure 66 is additionally disposed on the first optical enhancement structure 55. Thus, light emitted from the organic light emitting layer 22 can sequentially pass through the first and second optical enhancement structures 55 and 66 and emerge from a second light emerging surface 662 of the second optical enhancement structure 66. The refractive index sequence (from large to small) is the passivation layer 26, the first optical enhancement structure 55, and the second optical enhancement structure 66.

Similar to FIG. 9, the light beam on the edge that is totally reflected originally no longer satisfies the total reflection condition because of the presence of the arced profile of the first light emerging surface 51 of the first optical enhancement structure 55. Thus, the light beam on the edge refracts and emerges, such that light output efficiency is enhanced.

The reflective anode 20 suitable for use in the present invention can be ITO (indium-tin-oxide) or IZO (indium-zinc-oxide) combined with a reflective film or a high work function metal film. The organic light emitting layer 22 can include a hole transport layer (HTL), an emitting layer (EML) and an electron transport layer (ETL). The transparent cathode 24 can be formed by coating a transparent metal film. The passivation layer 26 can be a polymer.

The first and second optical enhancement structures can be a polymer and function to reduce total internal reflection. The first and second optical enhancement structures can be formed by coating, photolithography, and etching applied in the semiconductor process; or can be a thermoplastic formed in a mold.

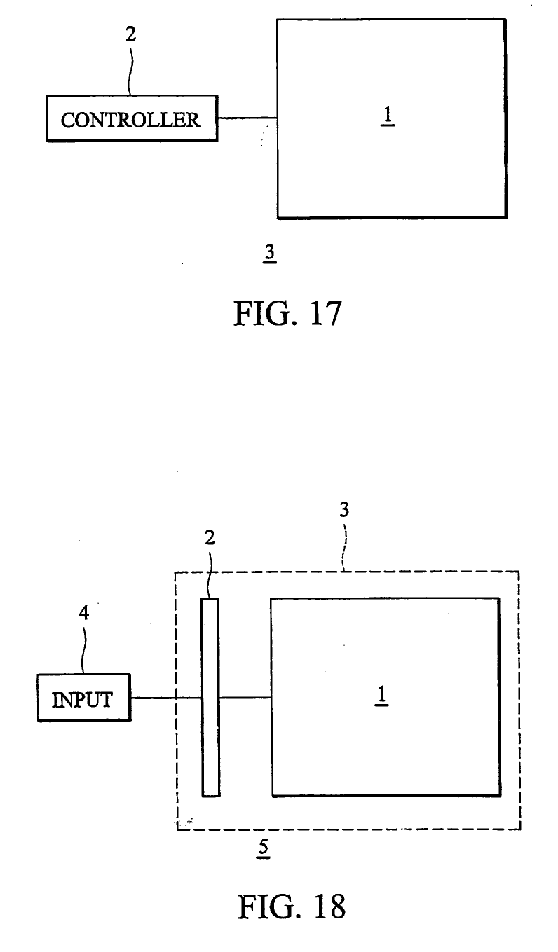

The light emitting device of the present can be coupled to a controller to form a light emitting display device. For example, the organic light emitting device 1 shown in FIG. 4 can be coupled to a controller 2, forming a light emitting display device 3 as shown in FIG. 17. The controller 2 can comprise a source and gate driving circuits (not shown) to control the light emitting device 1 to render image in accordance with an input. The light emitting display device 3 and associated controller 2 may be directed to an OLED type display device.

FIG. 18 is a schematic diagram illustrating an electronic device 5 incorporating the light emitting display device 3 shown in FIG. 17. An input device 4 is coupled to the controller 2 of the light emitting display device 3 shown in FIG. 17 to form an electronic device 5. The input device 4 can include a processor or the like to input data to the controller 2 to render an image. The electronic device 5 may be a portable device such as a PDA, notebook computer, tablet computer, cellular phone, or a display monitor device, or non-portable device such as a desktop computer.

Other types of light emitting devices may include PLED, plasma display panel (PDP), chemiluminescent display devices, backlit liquid crystal display devices, or the likes.

Computer simulation:

The models disclosed, of FIG. 3 (conventional), FIG. 4 (the present invention), FIG. 6 (the present invention), FIG. 8 (the present invention), FIG. 11 (the present invention), and FIG. 16 (conventional) were created by computer simulation.

The following parameters were established: reflectivity of the reflective anode 20 at 100%, organic light emitting layer 22 thickness of 0.15 μm with average refractive index of 1.75, transmittance of the transparent cathode at 100%, and pixel width 2000 μm.

FIG. 3 (conventional): the thickness of the passivation layer 900 is 1000 μm and n=1.4.

FIG. 4 (the present invention, single mesa type): the thickness of the passivation layer 26 is 1000 μm and n=1.46. The thickness of the first optical enhancement structure 30 is 275 μm and n=1.4. The first surface 311 has a width of 550 μm, and the second surface 312 has a curvature radius of 1500 μm.

FIG. 6 (the present invention, single mesa type): the thickness of the passivation layer 26 is 1000 μm and n=1.46. The thickness of the first optical enhancement structure 40 is 200 μm and n=1.4. The first surface 411 has a width of 1000 μm.

FIG. 8 (the present invention, single hemispherical type): the thickness of the passivation layer 26 is 1000 μm and n=1.46. The thickness of the first optical enhancement structure 50 is 200 μm and n=1.4. The first light emerging surface 51 has a curvature radius of 1500 μm.

FIG. 11 (the present invention, doublet lens type) the thickness of the passivation layer 26 is 700 μm and n=1.46. The thickness of the first optical enhancement structure 50 is 575 μm and n=1.4. The first surface 311 has a width of 1750 μm, and the second surface 312 has a curvature radius of 1800 μm. The second optical enhancement structure 62 has a thickness of 10 μm and n=1.3.

FIG. 16 (conventional, micro-lens type): the thickness of the passivation layer 920 is 1000 μm and n=1.4. The micro-lens array has a curvature radius of 10 μm.

The computer simulation results are shown in Table 1. It can be seen that the OLED pixel structure of the present invention greatly enhances light output efficiency.

TABLE 1

| | Optical | Light |
|---|---|---|
| | enhancement | output |
| FIG. | structure | efficiency |
| | None | 10% |
| (Conventional) | | |
| | Micro-lens type | 13% |
| (Conventional) | | |
| | Single mesa type | 19% |
| (The present invention) | | |
| | Single mesa type | 19% |
| (The present invention) | | |
| | Single | 18% |
| (The present invention) | hemispherical | |
| | type | |
| | Doublet lens | 23% |
| (The present invention) | Type | |

In conclusion, the present invention disposes an optical enhancement structure with special design in light output pathway of the organic light emitting device. Thus, the total reflection effect is reduced and light output efficiency is greatly enhanced.

The foregoing description of the preferred embodiments of this invention has been presented for purposes of illustration and description. Obvious modifications or variations are possible in light of the above teaching. The embodiments chosen and described provide an excellent illustration of the principles of this invention and its practical application to thereby enable those skilled in the art to utilize the invention in various embodiments and with various modifications as are suited to the particular use contemplated. For example, while the invention is illustrated by way of example of the optical enhancement layer being on side of the passivation layer away from the light emitting layer, the optical enhancement layer may be deployed above the light emitting layer, either below the passivation layer, or completely omitting the passivation layer. In other words, the optical enhancement layer may also function as a passivation layer. Also the optical enhancement layer may be a single layer of material having a refractive index gradient. All such modifications and variations are within the scope of the present invention as determined by the appended claims when interpreted in accordance with the breadth to which they are fairly, legally, and equitably entitled.

1. A light emitting device having a plurality of pixels, each pixel defined by a structure comprising:
a light emitting element, wherein some of the light from the light emitting element is emitted in a diverging manner; and
an optical enhancement structure that is optically coupled to the light emitting element, said optical enhancement structure having a light emerging surface that includes a central surface that is orthogonal to the normal and corner surfaces having profiles that are not orthogonal to the normal.

2. The light emitting device as in claim 1, wherein the light emerging surface having a surface profile that reduces total internal reflection at the light emerging surface.

3. The light emitting device as in claim 1, wherein the corner surface profiles comprise at least one of:
an arcuate profile,
a faceted profile, and
a beveled profile.

4. The light emitting device as in claim 3, wherein the surface profile comprises a convex light emerging surface.

5. The light emitting device as in claim 4, wherein the convex light emerging surface comprises an arcuate profile extending across the light emerging surface.

6. The light emitting device as in claim 5, wherein the optical enhancement structure directs diverging light from the light emitting element along a path within the optical enhancement structure in a direction towards a normal of the pixel.

7. The light emitting device as in claim 6, wherein the optical enhancement structure bends diverging light from the light emitting element to transmit along a path within the optical enhancement structure towards closer to the normal.

8. The light emitting device as in claim 7, further comprising a passivation layer between the light emitting element and the optical enhancement structure, wherein the refractive index of the optical enhancement structure is higher than the refractive index of the optical enhancement structure.

9. The light emitting device as in claim 1, wherein the optical enhancement structure comprises at least two adjacent optical elements having an interfacing surface between the adjacent optical elements, wherein the interfacing surface is shaped to reduce total internal reflection at the interfacing surface.

10. The light emitting device as in claim 9, wherein the interfacing surface includes a central surface that is orthogonal to the normal and corner surfaces having profiles that are not orthogonal to the normal.

11. The light emitting device as in claim 10, wherein the corner surface profiles comprise at least one of:
an arcuate profile,
a faceted profile, and
a beveled profile.

12. The light emitting device as in claim 11, wherein the interfacing surface comprises a convex surface.

13. The light emitting device as in claim 12, wherein the convex surface comprises an arcuate profile extending across the light emerging surface.

14. The light emitting device as in claim 13, wherein one of the optical elements comprises a substantially flat light emerging surface.

15. The light emitting device as in claim 14, wherein the optical elements have different refractive indices.

16. The light emitting device as in claim 15, wherein the optical element closer to the light emitting element has a higher refractive index than the optical element further from the light emitting element.

17. The light emitting device as in claim 16, further comprising a passivation layer disposed between the optical enhancement structure and the light emitting element, wherein the refractive index of the passivation layer is higher than the refractive indices of the optical elements.

18. The light emitting device as in claim 1, wherein the light emitting element is one of OLED, PLED and plasma panel display.

19. A display device, comprising:
a light emitting device as in claim 1; and
a controller operatively controlling the light emitting element of each pixel.

20. An electronic device, comprising:
the display device as in claim 19; and
a control device operatively controlling the operation of the display device to display an image in accordance with image data.

21. A method of enhancing light output from a light emitting element of a pixel in a light emitting device, comprising the steps of:
providing an optical enhancement structure that has an optical characteristic that refracts incident light to transmit along a path within the optical enhancement structure towards a normal of the structure; and
optically coupling the optical enhancement structure to the light emitting element to direct diverging light from the light emitting element along a path within the optical enhancement structure towards a normal of the pixel.
